(19) United States
(12) Patent Application Publication
(10) Pub. No.: US 2009/0043757 A1
(43) Pub. Date: Feb. 12, 2009

(54) METHOD AND SYSTEM FOR CREATING A REPRESENTATION OF A WEB PAGE USING KEYWORDS OR SEARCH PHRASES

(75) Inventors: Blake J. Corbitt, San Francisco, CA (US); Beau F. Lebens, San Francisco, CA (US); Charles R. Hentrich, JR., San Francisco, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Click Group, Inc., San Francisco, CA (US)

(21) Appl. No.: 11/837,352

(22) Filed: Aug. 10, 2007

(51) Int. Cl. G06F 17/30

(52) U.S. Cl. 707/5; 707/3

(57) ABSTRACT

The invention provides a method of providing information over a network, comprising preparing a representation of a web page, wherein A computer program may compile the representation from a plurality of information sources that may be included in the representation, the information sources including a plurality of keywords or search phrases, and providing the representation to a search engine.

### BACKGROUND TO THE INVENTION

1). Field of the Invention

This invention relates to a method and a system for providing information over a network such as the internet.

2). Discussion of the Related Art

Computer systems can be used for accessing and downloading pages and documents from remote sites over the internet. These remote sites can be accessed by entering a uniform resource locator (URL) in an address box in a browser.

Search engines are often used to find webpages, documents and other content over the internet. A server site crawler regularly collects data from remote sites over the internet, and the data is indexed into a search database. A search engine provider provides an interface with a search box for entering a search query. The search query is transmitted from the search engine site to the server, and is used-to parse or extract data from the search database. A search results page is then transmitted from the server to the client site, and lists a plurality of URLs that can be selected by a user to direct the user to selected ones of the remote sites.

### SUMMARY OF THE INVENTION

The invention provides a method of providing information over a network, comprising preparing a representation of a web page, wherein A computer program may compile the representation from a plurality of information sources that may be included in the representation, the information sources including a plurality of keywords or search phrases, and providing the representation to a search engine.

The keywords or search phrases form an output search phrase, the method further comprising utilizing a predetermined tag to extract the output search phrase.

The method may further comprise utilizing an input search phrase to generate a plurality of tags, the predetermined tag being one of the plurality of tags

The plurality of tags may be synonyms for portions of the input search phrase.

The method may further comprise utilizing the predetermined tag to extract a plurality of output search phrases used for preparing the representation.

The method may further comprise storing the representation at a representation location, and transmitting a crawling link to the search engine, the crawling link being utilized by a crawler to access and copy the representation from the representation location to the search database.

The method may further comprise receiving the request for the web page from the client location, and redirecting the client location the web page after receiving the request.

The method may further comprise storing an account balance corresponding to the client location, an action being performed upon receiving the request for the web page depending on at least the account balance.

The method may further comprise predicting a future balance of the account based on at least a rate of requests for the web page, the action being performed being at least partially based on said prediction.

The action being performed may be that the client location may be directed to different web pages depending on at least the account balance.

The web pages may be stored at a plurality of web page locations, a search request transmitted from a client location connected over the network to, the search engine being utilized at the search engine to extract at least one of the representations of the web pages from a search database connected to the search engine, and the search engine transmitting at least one search result link from the client location, the search result link being based on the representation that may be extracted and the search result link being utilized at the client location to transmit a request for the web page over the network such that the web page may be transmitted from the web page location to the client location in response to the request from the client location for the web page.

The invention also provides a computer-readable medium having stored thereon a set of instructions that executable by a processor of at least one computer to provide information over a network according to a method comprising preparing a representation of a web page, wherein A computer program may compile the representation from a plurality of information sources that may be included in the representation, the information sources including a plurality of keywords or search phrases, and providing the representation to a search engine.

The keywords or search phrases form an output search phrase, the method further comprising utilizing a predetermined tag to extract the output search phrase.

The method may further comprise utilizing an input search phrase to generate a plurality of tags, the predetermined tag being one of the plurality of tags

The plurality of tags may be synonyms for portions of the input search phrase.

The method may further comprise utilizing the predetermined tag to extract a plurality of output search phrases used for preparing the representation.

The computer-readable medium may further comprise storing the representation at a representation location, and transmitting a crawling link to the search engine, the crawling link being utilized by a crawler to access and copy the representation from the representation location to the search database.

The computer-readable medium may further comprise receiving the request for the web page from the client location, and redirecting the client location the web page after receiving the request.

The computer-readable medium may further comprise storing an account balance corresponding to the client location, an action being performed upon receiving the request for the web page depending on at least the account balance.

The computer-readable medium may further comprise predicting a future balance of the account based on at least a rate of requests for the web page, the action being performed being at least partially based on said prediction.

The action being performed may be that the client location may be directed to different web pages depending on at least the account balance.

The web pages may be stored at a plurality of web page locations, a search request transmitted from a client location connected over the network to the search engine being utilized at the search engine to extract at least one of the representations of the web pages from a search database connected to the search engine, and the search engine transmitting at least one search result link from the client location, the search result link being based on the representation that may be extracted and the search result link being utilized at the client location to transmit a request for the web page over the network such that the web page may be transmitted from the web page location to the client location in response to the request from the client location for the web page.

The invention also provides a method of providing information over a network, comprising storing a plurality of web pages at a plurality of web page locations, preparing a representation of one of the web pages, wherein A computer program may compile the representation from a plurality of information sources that may be included in the representation, the information sources including a plurality of keywords or search phrases, storing the representation among a plurality of representations of the web pages in a search engine database connected to a search engine, transmitting a search request from a client location connected over the network to the search engine, utilizing the search request at the search engine to extract at least one of the representations of the web pages, transmitting at least one search result link from the search engine to the client location, the search result link being based on the representation for the web page that may be extracted, utilizing the search result link at the client location to transmit a request for the web page over the network, and transmitting the web page from the web page location to the client location in response to the request from the client location for the web page.

The keywords or search phrases form an output search phrase, the method further comprising utilizing a predetermined tag to extract the output search phrase.

The method may further comprise utilizing an input search phrase to generate a plurality of tags, the predetermined tag being one of the plurality of tags

The plurality of tags may be synonyms for portions of the input search phrase.

The method may further comprise utilizing the predetermined tag to extract a plurality of output search phrases used for preparing the representation.

The invention also provides a system for providing information over a network, comprising a computer program which may include a module to create a representation of a web page keywords or search phrases, a module to store the representation at a representation location, and a module to transmit a crawling link to the search engine, the crawling link being utilized by a crawler to access and copy the representation from the representation location to the search database, to provide the representation to a search engine.

The keywords or search phrases form an output search phrase, the system further comprising an output search phrase generator including a module that utilizes a predetermined tag to extract the output search phrase.

The output search phrase generator further may include a module that utilizes an input search phrase to generate a plurality of tags, the predetermined tag being one of the plurality of tags

The plurality of tags may be synonyms for portions of the input search phrase.

The module that utilizes a predetermined tag to extract the output search phrase utilizes the predetermined tag to extract a plurality of output search phrases used for preparing the representation.

The computer system may further comprise a module for storing the representation at a representation location, and a module for transmitting a crawling link to the search engine, the crawling link being utilized by a crawler to access and copy the representation from the representation location to the search database.

The computer system may further comprise module for receiving the request for the web page from the-client location, and a module redirecting the client location the web page after receiving the request.

The computer system may further comprise a module for storing an account balance corresponding to the client location, an action being performed upon receiving the request for the web page depending on at least the account balance.

The computer system may further comprise a module for predicting a future balance of the account based on at least a rate of requests for the web page, the action being performed being at least partially based on said prediction.

The action being performed may be that the client location may be directed to different web pages depending on at least the account balance.

The web pages may be stored at a plurality of web page locations, a search request transmitted from a client location connected over the network to the search engine being utilized at the search engine to extract at least one of the representations of the web pages from a search database connected to the search engine, and the search engine transmitting at least one search result link from the client location, the search result link being based on the representation that may be extracted and the search result link being utilized at the client location to transmit a request for the web page over the network such that the web page may be transmitted-from the web page location to the client location in response to the request from the client location for the web page.

### BRIEF DESCRIPTION OF THE DRAWINGS

The invention is further described by way of example with reference to the accompanying drawings wherein:

FIG. 1 is a block diagram of a portion of a system for providing information over a network, in particular illustrating a control system thereof;

FIGS. 2A and 2B are a flowchart showing operation of the system of FIG. 1;

FIG. 3 is an interface of a webpage management program forming part of the control system in the view of FIG. 1;

FIG. 4 is a block diagram showing further components of the system for providing information over a network, in particular, showing a search engine server thereof;

FIG. 5 is a block diagram of further components of the control system shown in FIG. 1 that are used for directing a client location based on a predictive future balance of an account;

FIG. 6 is a view of an interface forming part of a client management program shown in FIG. 5;

FIG. 7 is a graph illustrating how an account balancer is predicted and remaining days on the account balance are predicted;

FIG. 8 is a block diagram of a keyword or search phrase building system that is used for generating keywords or search phrases for entry in the interface shown in FIG. 3; and

FIG. 9 is a block diagram of a computer system that may find application in the system.

### DETAILED DESCRIPTION OF THE INVENTION

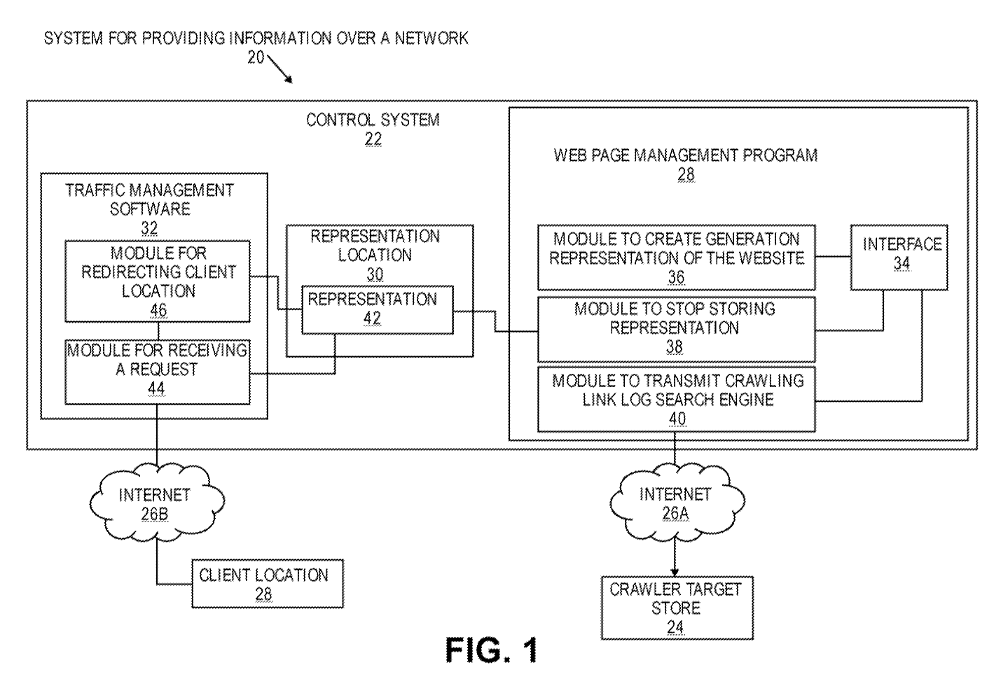

FIG. 1 of the accompanying drawings illustrates a system 20 for providing information over a network, including a control system 22, a crawler target store 24 connected to the control system 22 over a network in the form of the internet 26A, and a client location 28 connected to the control system 22 over the internet 26B.

The control system 22 includes a webpage management program 28, a representation location 30 connected to the webpage management program 28, and traffic management software 32 connected to the representation location 30. The webpage management program 28 includes an interface 34, a generation module 36 to create a representation of a website, a storing module 38 to store a representation, and transmission module 40 to transmit a crawling link to a search engine. The generation module 36, storing module 38, and transmission module 40 are connected to one another. The interface 34 is connected to control functioning of the generation module 36, storing module 38 and transmission module 40.

The representation location 30 is accessible over the internet 26B. One or more representations 42 can be stored by the storing module 38 in the representation location 30.

The traffic management software 32 includes a module 44 for receiving a request and a module 46 for redirecting a client location. The module 44 for receiving the request and the module 46 for directing the client location are both connected to the representation 42 at the representation location 30.

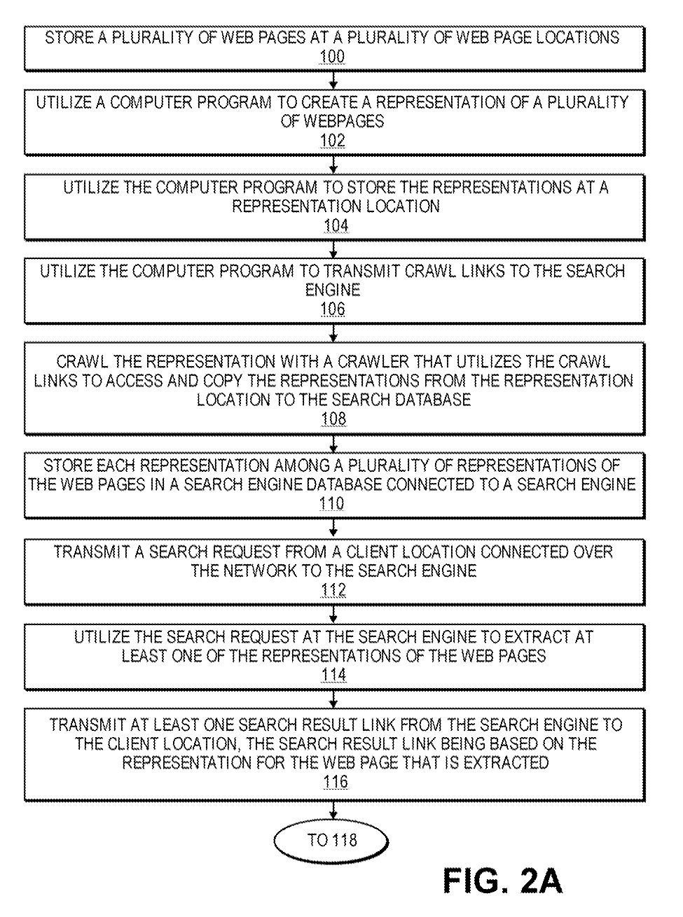

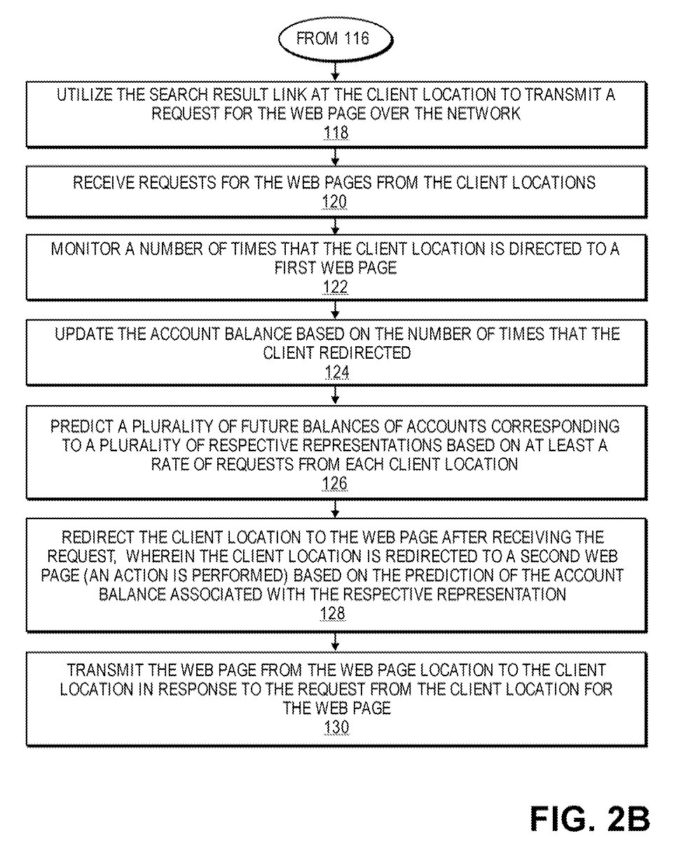

In use, as illustrated in FIG. 2, a plurality of webpages (not shown in FIG. 1) are stored at a plurality of webpage locations (not shown) (step 100). The webpages typically include information relating to goods, services or content for sale. The webpage management program 28 is a computer program that is utilized to create a representation 42 of each one of the webpages (step 102). The interface 34 and the generation module 36 of the webpage management program 28 are used to create the representations 42.

Next, the webpage management program 28 is utilized to store the representations 42 at the representation location 30 (step 104). The interface 34 and the storing module 38 are used to store the representations 42 at the representation location 30.

Next, the webpage management program 28 is utilized to transmit crawl links to the crawler target store 24 of the search engine (step 106). The interface 34 and the transmission module 40 are used to transmit the crawl links to the search engine.

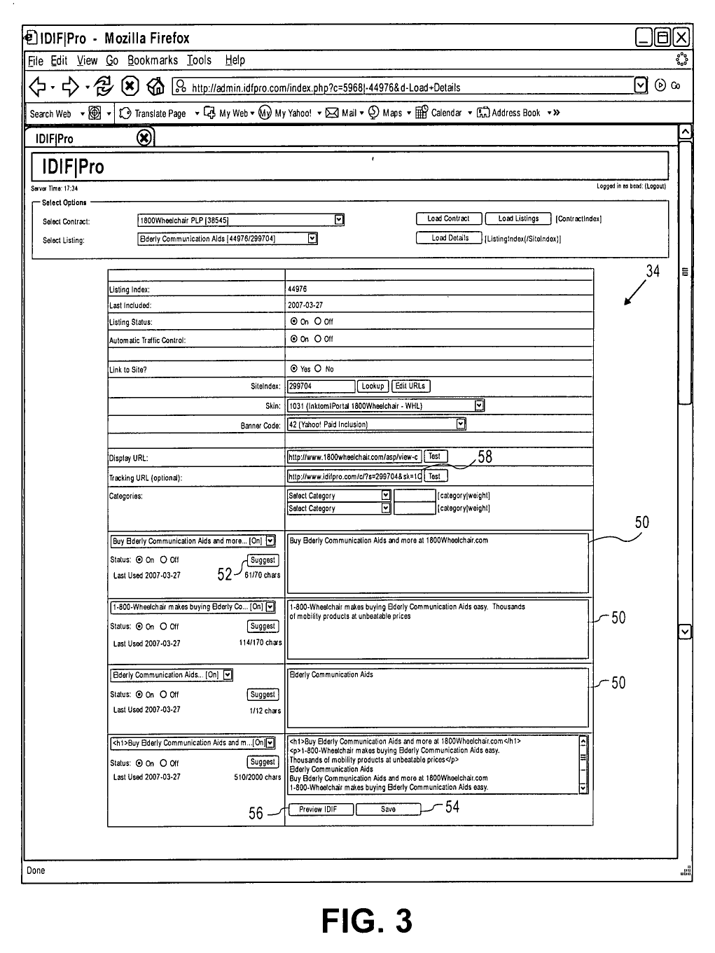

FIG. 3 shows one part of the interface 34 that includes information fields 50 for entering text relating to the website for which the representation is created. The data within the information fields 50 can be entered using a keyboard. Alternatively, the data within the information fields 50 can be generated by selecting a “suggest” button 52 next to and associated with each one of the information fields 50.

A “save” button 54 is provided at the bottom of the interface 34. Upon selection of the save button, the representation 42 in FIG. 1 is automatically generated using the generation module 34 and is automatically stored at the representation location 30 using the storing module 38. A user may alternatively select a “preview” button 56, upon which the representation 42 is automatically created and displayed without storing the representation 42 at the representation location 30.

The interface 34 also has a target link field 58. A URL is associated with the representation 42 located at the representation location 30. The URL of the representation 42 is a target link that is entered in the target link field 58. The target link within the target link field 58 is the target link that is transmitted by the transmission module 40 in FIG. 1 over the internet 26A to the crawler target store. The target link within the target link field 58 can be transmitted upon selection of the “save” button 54. Alternatively, another view of the interface 34 can be used to transmit a plurality of target links, associated with respective representations, over the internet 26A to the crawler target store 24. The interface 34 also has a listing status selector next to the heading “Listing Status.” When the listing status is switched from “On” to “Off”, the representation that will be saved will be blank, but the target link will still be transmitted. The listing status selector allows for an account manager to switch an account “On” to “Off” based-on payment or other reasons.

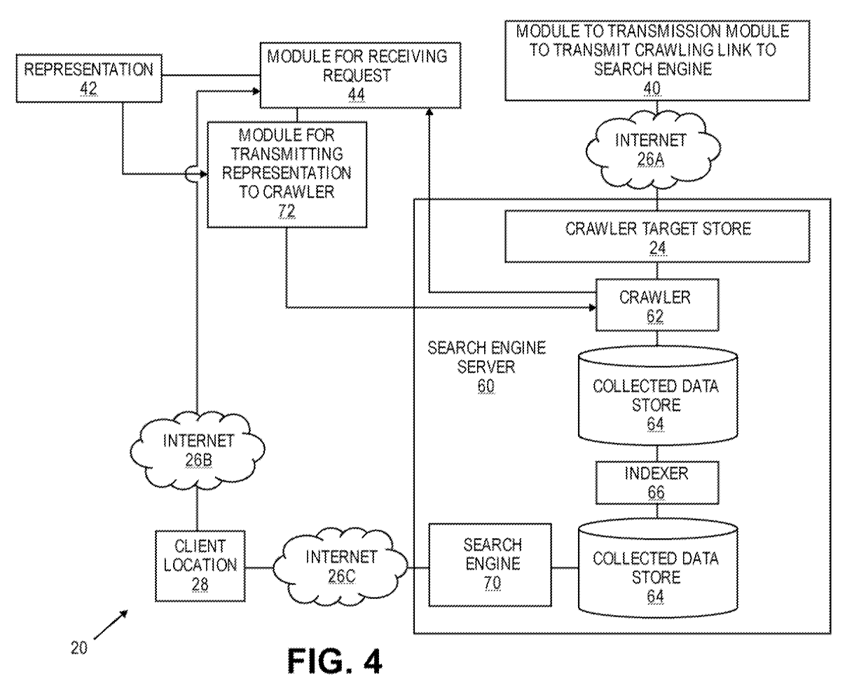

FIG. 4 shows a search engine server system 60 forming part of the system 20 for providing information over a network. The search engine server system 60 includes the crawler target store 24, a crawler 62, a collected data store 64, an indexer 66, a search database 68 and search engine 70 all connected to one another in series. The search engine 70 is connected over the internet 26C to a plurality of client locations 28 (only one of which is shown).

Also shown in FIG. 4 is a module 72 for transmitting a representation to the crawler. The module 72 forms part of the control system 22 shown in FIG. 1. The module 72 is connected between the representation 42 and the crawler 62. The crawler 62 is also connected to the module 44 for receiving a request, shown in FIG. 1.

With further reference to FIGS. 2 and 4, the crawler 62 crawls the representations 42 (step 108). The crawler 62 utilizes the crawl links in the crawler target store 24 to access and copy the representations 42 and then stores the copies in the collected data store 64. The module 44 for receiving a request is a small program with which the crawler 62 can communicate and which is responsible for directing the crawler 62 to the representation 42. The module 72 for transmitting a representation to the crawler is also a small program that transmits the representation 42 to the crawler 62.

A plurality of representations, such as the representation 42, are stored in the collected data store 64. The indexer 66 indexes the representations 42 into a searchable form and stores the indexed representations in the search database 68. The representation 42 is thus stored among a plurality of representations of webpages in the search database 68 connected to the search engine 70 (step 110).

In use, a client at the client location 28 transmits a search request from the client location 28 over the internet 26 to the search engine 70 (step 112). The search engine 70 then utilizes the search request to extract at least one of the representations of the webpages from the search database 68 (step 114). The search engine 70 then extracts a search result link from the representation that is extracted from the search database 68. The search engine 70 then transmits the (at least one) search result link from the search engine 70 over the internet 26C to the client location (step 116). The search result link is based on the representation of the webpage that is extracted.

In the present example, the client at the client location 28 will access an interface of the search engine by transmitting the following URL:

http://search.yahoo.com/

The client at the client location 28 then enters a search criteria or a search string in the present example “wheelchair”, and transmits the search request from the client location 28 over the internet 26C to the search engine 70. The search engine 70 then transmits a webpage over the internet 26C to the client location 28, the webpage having the following address:

http://search.yahoo.com/search;_ylt=A0geu8EetDdGc3gBz0JXNyoA?p=1800wheelchair&ei=UTF−8&fr=sfp&x=wrt

The webpage that is transmitted to the client location 28 includes a plurality of search results, one of which being for “1800 wheelchair”.

A client at the client location 28 then utilizes the search result link for “1800 wheelchair” to transmit a request for the webpage over the internet 26B (step 118). The selection by the client at the client location 28 of the search result for “1800 wheelchair” directs the client location through the module 44 for receiving a request to the representation 42. The client location 28 may not be directed directly to the module 44 and may pass through an intermediate system forming part of the search engine server system 60, represented by the following address:

http://rds.yahoo.com/_ylt=A0geu8cktDdGOxwB4zdXNyoA;_ylu=X3oD MTE2NTBlOTE4BGNvbG8DZQRsA1dTMQRwb3MDMQRzZWMDc3IEdnRpZ ANGNjY1Xzgz/SIG=1ae048b8j/EXP=1178142116/**http%3a//rdre1.yahoo.com/clic k%3fu=http%3a//www.idifpro.com/c/%253Fs%253D197940%2526sk%253D1031% 2526b%253D42%26y=04E26DDE0C33D70BC6%26i=482%26c=35614%26q=02%255 ESSHPM%255BL7.%2527//hwzzs%257Cw˜vm6%26e=utf8%26r=0%26d=wow˜F6 65-en-us%26n=0274K1NILCRKC0K3%26s=11%26t=%26m=4637B425%26x-058F8 A6D3CC4FE5C3A3B251EEC7ACF3007

The string above includes the address for the representation 42, namely:

http://www.1800wheelchair.com/?s_cid=w1_{—}0000001

The intermediate system forming part of the search engine server system 60 directs the client location 28 to the module 44, which receives the request for the webpage from the client location 28 (step 120).

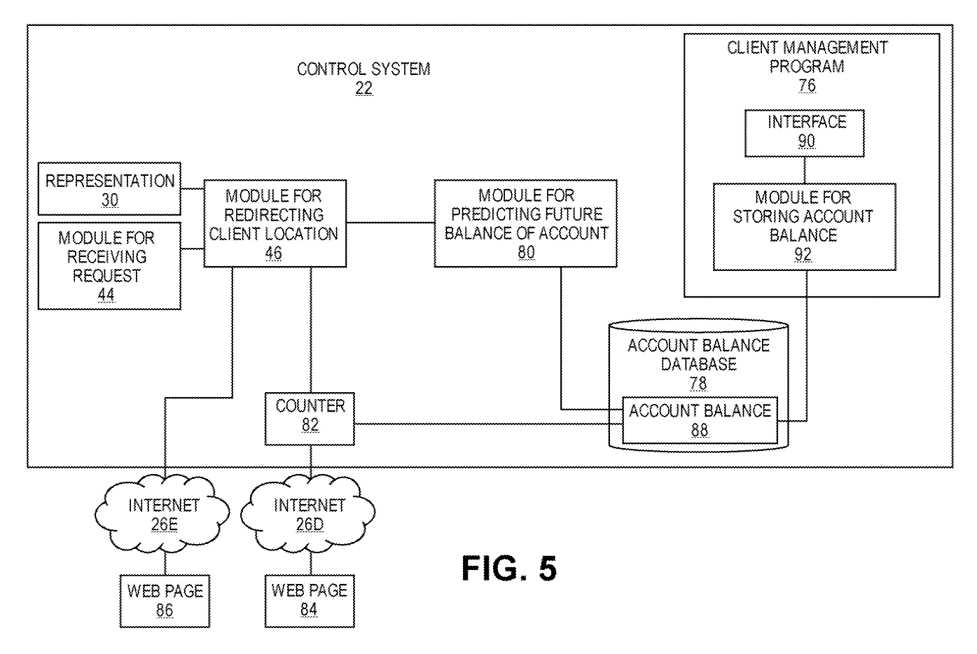

FIG. 5 illustrates further components of the control system 22 shown in FIG. 1, including a client management program 76, an account balance database 78, a module 80 for predicting a future balance of an account, and a counter 82. Also shown in FIG. 5 are first and second webpages 84 and 86, which are typically managed by the same website operator. The webpage 84 is typically the webpage for which the representation 30 is created.

The account balance database 78 includes a plurality of account databases 88 (only one of which is shown). The client management program 76 includes an interface 90 and a module 92 for storing an account balance. The interface 90 is connected to the module 92 for storing an account balance. The module 92 for storing an account balance is connected to the account balance database 78 for purposes of storing the account balance 88. The account balance 88 is one of multiple account balances that are stored in the account balance database 78. Each account balance stored in the account balance database 78 is associated with a respective one of a plurality of representations such as the representation 30 and a plurality of webpages such as the webpage 84.

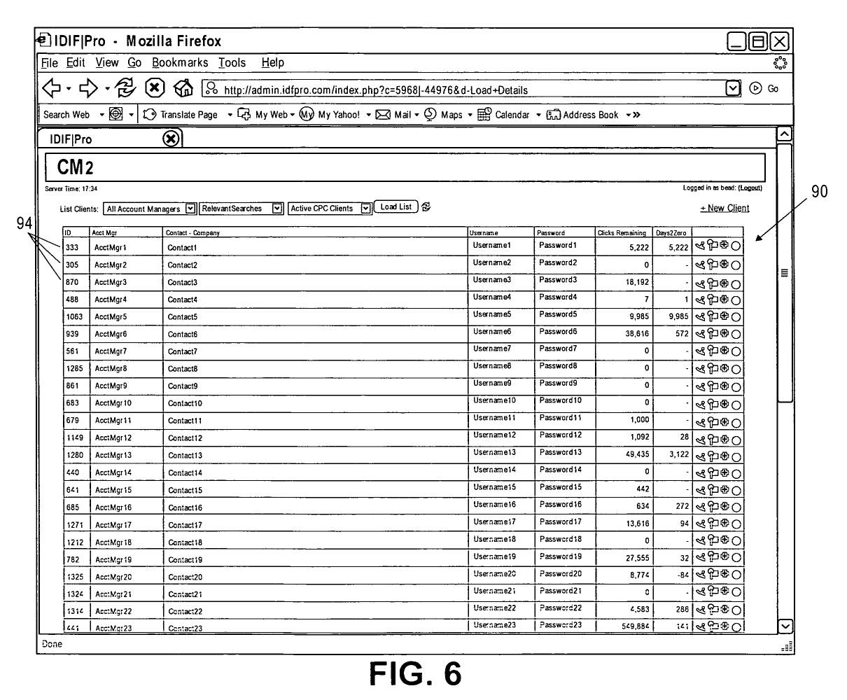

FIG. 6 illustrates the interface 90 of the client management program 76 in FIG. 5. As shown in the interface 90, a plurality of accounts 94 are stored in the client management program 76. Each account 94 shows a respective balance under the heading “Clicks Remaining”. An account manager can select respective ones of the accounts 94 and update the account balance based on recent payment history. Referring again to FIG. 5, the module 92 for storing the account balance then stores the respective account balance 88 entered by the account manager in the account balance database 78.

The module 80 for predicting a future balance of an account is connected to each account balance 88 in the account balance database 78. The module 46 for redirecting a client location is connected to the module 80 for predicting a future balance of an account. The module 46 for redirecting a client location is connected to through the counter 82 and the internet 26D to the webpage 84. The module 46 for redirecting a client location is also connected through the internet 26E to the webpage 86

With reference to FIGS. 2 and 5, the control system 22 monitors a number of times that a client location 28 (FIGS. 1 and 4) is directed to the webpage 84 (step 122). The module 46 for redirecting a client location receives the webpage request previously submitted by the client location 28 from the module 44 for receiving requests. The module 46 for redirecting a client location then extracts the address of the webpage 84 from the representation 30. In the present example, the address of the webpage 84 is:

http://www.1800wheelchair.com/?s_cid=w1_{—}0000001

The module 46 for redirecting a client location then directs the client location through the counter 82 and the internet 26D to the webpage 84. When traffic is directed through the counter 82, the counter updates the account balance 88 associated with the representation 30 (step 124). Other account balances within the account balance database 78 remain unchanged. As a result, the number of clicks remaining in a respective account in the interface 90 are reduced by one.

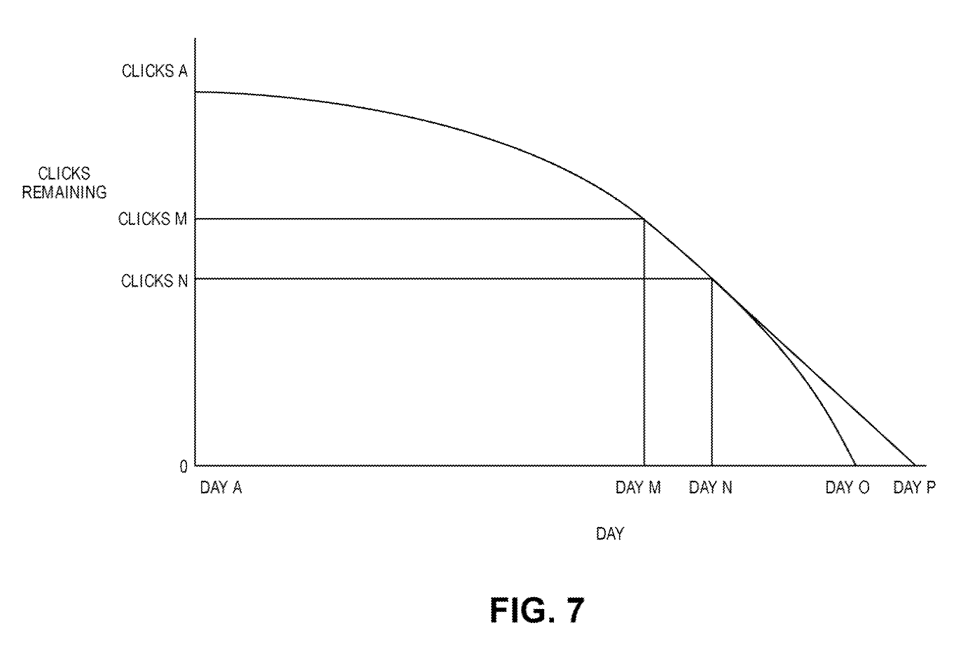

he module 80 for predicting a future balance of an account predicts the balance as shown in FIG. 7. The number of clicks remaining in an account reduces from clicks A to clicks M, clicks N and zero on day A, day M, and day O respectively. On any particular day, the number of clicks remaining are linearized. For example, on day N, a future day P is predicted when the number of clicks will be zero. The future date P is calculated by first calculating a slope, or a usage rate, of clicks between day M and day N and providing for the fact that clicks N are still remaining on day N. Other numerical methods can be employed to predict a future balance and when the balance will be zero.

In a similar manner, a plurality of future balances of accounts corresponding to a plurality of respective representations are predicted based on at least a rate of requests from each client location (step 126). The module 80 for predicting future balances of account provides the remaining days of each account to the module 46 for redirecting a client location.

The module 46 for redirecting a client location redirects the client location to the webpage 84 after receiving the request from the module 44 for receiving requests. The client location is redirected to the webpage 86 (and action is performed) based on the prediction of the account balance associated with the respective representation 30 (step 128). More specifically, if the remaining number of days between day P and day N in FIG. 7 is less than a predetermined number of days, typically less than three days, the client location is not directed to the webpage 84 and is instead directed to the webpage 86. Depending on which webpage 84 or 86 the client location is directed to, the respective webpage 84 or 86 is then transmitted from a webpage location where the respective webpage 84 or 86 is located to the client location 28 (step 130). The addresses for the web pages 84 and 86 are entered using a window (not shown) of the interface 34 in FIG. 3.

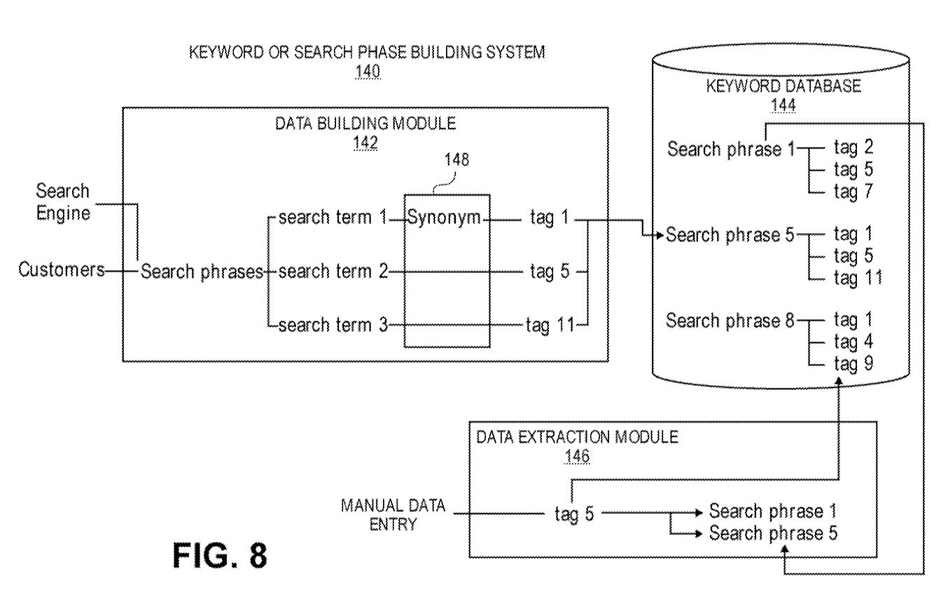

FIG. 8 illustrates a keyword or a search phrase building system 140 that is used to generate keywords or search phrases that are entered in the fields 50 of the interface 34 in FIG. 3. The keyword or search phase building system 140 includes a data building module 142, a keyword database 144, and a data extraction module 146.

The data building module 142 receives input search phrases (search phrase 5) from various sources such as search engines or from customers, The data building module 142 separates each search phrase into a plurality of search terms (search term 1, search term 2 and search term 3). The data building module 142 has a synonym generating engine 148. The synonym generating engine 148 generates a synonym or tag (tag 1, tag 2, and tag 11) corresponding to each one of the search terms. The search phrase (search phrase 5) and the tags (tag 1, tag 5, and tag 11) are then stored in the search database 144 with the tags being associated with the search phrase.

In a similar manner, a plurality of search phrases (search phrase 1, search phrase 5 and search phrase 8) are stored in the keyword database 144 with a respective set of tags associated with each one of the search phrases.

An operator can get a general impression of a webpage for which a representation has to be prepared. Manual data entry is used to enter a tag (tag 5) in the data extraction module 146. The tag that is entered into the data extraction module 146 will be representative of the webpage for which the representation has to be prepared. It is possible to enter more than one tag into the data extraction module 146. The data extraction module 146 then performs a reverse lookup in the keyword database 144. All the search phrases and only the search phrases having the tag that is entered in the data extraction module 146 associated therewith are extracted, In the present example, search phrase 1 and search phrase 5 have tag 5 associated therewith. Search phrase 1 and search phrase 5 are entered into one of the information fields 50 of the user interface 34 in FIG. 3.

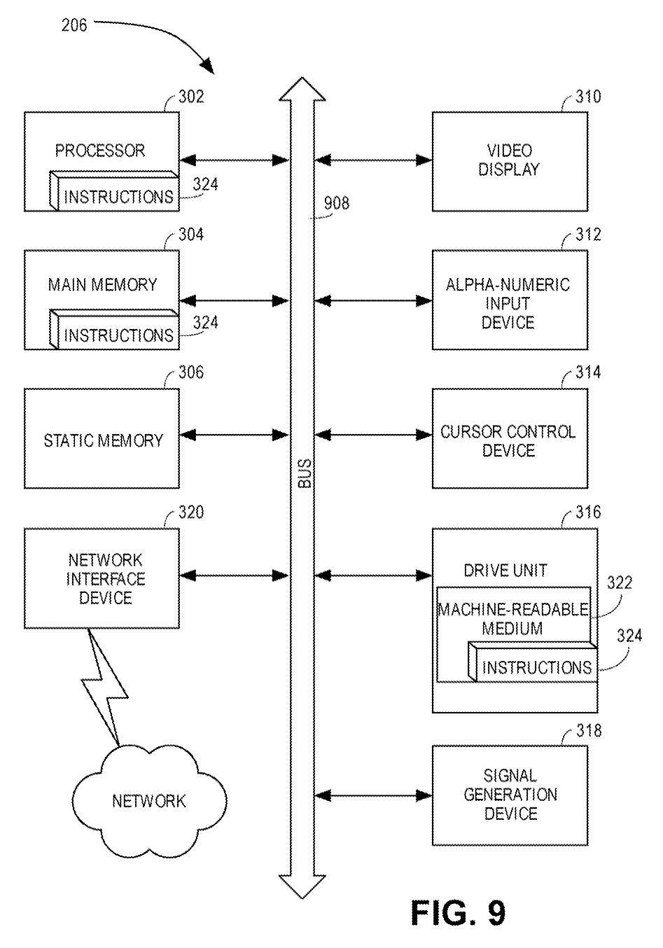

FIG. 9 shows a diagrammatic representation of a machine in the exemplary form of a computer 206 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or muitiple sets) of instructions to perform any one or more of the methodologies discussed herein.

The exemplary client computer 206 includes a processor 330 (e.g., a central processing unit (CPU), a graphics processing unit (GPU), or both), a main memory 332 (e.g., read-only memory (ROM), flash memory, dynamic random access memory (DRAM) such as synchronous DRAM (SDRAM) or Rambus DRAM (RDRAM), etc.), and a static memory 334 (e.g., flash memory, static random access memory (SRAM), etc.), which communicate with each other via a bus 336.

The client computer 206 may further include a video display 338 (e.g., a liquid crystal display (LCD) or a cathode ray tube (CRT)). The client computer 206 also includes an alpha-numeric input device 340 (e.g., a keyboard), a cursor control device 342 (e.g., a mouse), a disk drive unit 344, a signal generation device 346 (e.g., a speaker), and a network interface device 348.

The disk drive unit 344 includes a machine-readable medium 350 on which is stored one or more sets of instructions 352 (e.g., software) embodying any one or more of the methodologies or functions described herein. The software may also reside, completely or at least partially, within the main memory 332 and/or within the processor 330 during execution thereof by the client computer 206, the main memory 332 and the processor 330 also constituting machine-readable media. The software may further be transmitted or received over a network 354 via the network interface device 348.

While the machine-readable medium 352 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of providing information over a network, comprising:
preparing a representation of a web page, wherein a computer program compiles the representation from a plurality of information sources that are included in the representation, the information sources including a plurality of keywords or search phrases; and
providing the representation to a search engine.

2. The method of claim 1, wherein the keywords or search phrases form an output search phrase, the method further comprising:
utilizing a predetermined tag to extract the output search phrase.

3. The method of claim 2, further comprising:
utilizing an input search phrase to generate a plurality of tags, the predetermined tag being one of the plurality of tags

4. The method of claim 3, wherein the plurality of tags are synonyms for portions of the input search phrase.

5. The method of claim 2, further comprising:
utilizing the predetermined tag to extract a plurality of output search phrases used for preparing the representation.

6. The method of claim 1, further comprising:
storing the representation at a representation location; and
transmitting a crawling link to the search engine, the crawling link being utilized by a crawler to access and copy the representation from the representation location to the search database.

7. The method of claim 1, further comprising:
receiving the request for the web page from the client location; and
redirecting the client location the web page after receiving the request.

8. The method of claim 7, further comprising:
storing an account balance corresponding to the client location, an action being performed upon receiving the request for the web page depending on at least the account balance.

9. The method of claim 8, further comprising:
predicting a future balance of the account based on at least a rate of requests for the web page, the action being performed being at least partially based on said prediction.

10. The method of claim 8, wherein the action being performed is that the client location is directed to different web pages depending on at least the account balance.

11. The method of claim 1, wherein the web pages are stored at a plurality of web page at a plurality of web page locations, a search request transmitted from a client location connected over the network to the search engine being utilized at the search engine to extract at least one of the representations of the web pages from a search database connected to the search engine, and the search engine transmitting at least one search result link from the client location, the search result link being based on the representation that is extracted and the search result link being utilized at the client location to transmit a request for the web page over the network such that the web page is transmitted from the web page location to the client location in response to the request from the client location for the web page.

12. A computer-readable medium having stored thereon a set of instructions that executable by a processor of at least one computer to provide information over a network according to a method comprising:
preparing a representation of a web page, wherein a computer program compiles the representation from a plurality of information sources that are included in the representation, the information sources including a plurality of keywords or search phrases; and
providing the representation to a search engine.

13. The method of claim 12, wherein the keywords or search phrases form an output search phrase, the method further comprising:
utilizing a predetermined tag to extract the output search phrase.

14. The method of claim 13, further comprising:
utilizing an input search phrase to generate a plurality of tags, the predetermined tag being one of the plurality of tags

15. The method of claim 14, wherein the plurality of tags are synonyms for portions of the input search phrase.

16. The method of claim 13, further comprising:
utilizing the predetermined tag to extract a plurality of output search phrases used for preparing the representation.

17. The computer-readable medium of claim 12, further comprising:
storing the representation at a representation location; and
transmitting a crawling link to the search engine, the crawling link being utilized by a crawler to access and copy the representation from the representation location to the search database.

18. The computer-readable medium of claim 12, further comprising:
receiving the request for the web page from the client location; and
redirecting the client location the web page after receiving the request.

19. The computer-readable medium of claim 18, further comprising:
storing an account balance corresponding to the client location, an action being performed upon receiving the request for the web page depending on at least the account balance.

20. The computer-readable medium of claim 19, further comprising:
predicting a future balance of the account based on at least a rate of requests for the web page, the action being performed being at least partially based on said prediction.

21. The computer-readable medium of claim 19, wherein the action being performed is that the client location is directed to different web pages depending on at least the account balance.

22. The computer-readable medium of claim 12, wherein the web pages are stored at a plurality of web page at a plurality of web page locations, a search request transmitted from a client location connected over the network to the search engine being utilized at the search engine to extract at least one of the representations of the web pages from a search database connected to the search engine, and the search engine transmitting at least one search result link from the client location, the search result link being based on the representation that is extracted and the search result link being utilized at the client location to transmit a request for the web page over the network such that the web page is transmitted from the web page location to the client location in response to the request from the client location for the web page.

23. A method of providing information over a network, comprising:
storing a plurality of web pages at a plurality of web page locations;
preparing a representation of one of the web pages, wherein a computer program compiles the representation from a plurality of information sources that are included in the representation, the information sources including a plurality of keywords or search phrases;
storing the representation among a plurality of representations of the web pages in a search engine database connected to a search engine;
transmitting a search request from a client location connected over the network to the search engine;
utilizing the search request at the search engine to extract at least one of the representations of the web pages;
transmitting at least one search result link from the search engine to the client location, the search result link being based on the representation for the web page that is extracted;
utilizing the search result link at the client location to transmit a request for the web page over the network; and
transmitting the web page from the web page location to the client location in response to the request from the client location for, the web page.

24. The method of claim 23, wherein the keywords or search phrases form an output search phrase, the method further comprising:
utilizing a predetermined tag to extract the output search phrase.

25. The method of claim 24, further comprising:
utilizing an input search phrase to generate a plurality of tags, the, predetermined tag being one of the plurality of tags

26. The method of claim 25, wherein the plurality of tags are synonyms for portions of the input search phrase.

27. The method of claim 24, further comprising:
utilizing the predetermined tag to extract a plurality of output search phrases used for preparing the representation.

28. A system for providing information over a network, comprising:
a computer program which includes:
a module to create, a representation of a web page keywords or search phrases;
a module to store the representation at a representation location; and
a module to transmit a crawling link to the search engine, the crawling link being utilized by a crawler to access and copy the representation from the representation location to the search database, to provide the representation to a search engine.

29. The computer system of claim 28, wherein the keywords or search phrases form an output search phrase, the system further comprising an output search phrase generator including:
a module that utilizes a predetermined tag to extract the output search phrase.

30. The computer system of claim 29, wherein the output search phrase generator further includes:
a module that utilizes an input search phrase to generate a plurality of tags, the predetermined tag being one of the plurality of tags

31. The computer system of claim 30, wherein the plurality of tags are synonyms for portions of the input search phrase.

32. The computer system of claim 29, therein the module that utilizes a predetermined tag to extract the output search phrase utilizes the predetermined tag to extract a plurality of output search phrases used for preparing the representation.

33. The computer system of claim 28, further comprising:
a module for storing the representation at a representation location; and
a module for transmitting a crawling link to the search engine, the crawling link being utilized by a crawler to access and copy the representation from the representation location to the search database.

34. The computer system of claim 28, further comprising:
module for receiving the request for the web page from the client location; and
a module redirecting the client location the web page after receiving the request.

35. The computer system of claim 34, further comprising:
a module for storing an account balance corresponding to the client location, an action being performed upon receiving the request for the web page depending on at least the account balance.

36. The computer system of claim 34, further comprising:
a module for predicting a future balance of the account based on at least a rate of requests for the web page, the action being performed being at least partially based on said prediction.

37. The computer system of claim 34, wherein the action being performed is that the client location is directed to different web pages depending on at least the account balance.

38. The computer system of claim 37, wherein the web pages are stored at a plurality of web page at a plurality of web page locations, a search request transmitted from a client location connected over the network to the search engine being utilized at the search engine to extract at least one of the representations of the web pages from a search database connected to the search engine, and the search engine transmitting at least one search result link from the client location, the search result link being based on the representation that is extracted and the search result link being utilized at the client location to transmit a request for the web page over the network such that the web page is transmitted from the web page location to the client location in response to the request from the client location for the web page.
